(19) United States
(12) Patent Application Publication
(10) Pub. No.: US 2004/0093918 A1
(43) Pub. Date: May 20, 2004

(54) Security system for wheeled apparatus

(76) Inventors: Roger J. Leyden, Willow Springs, IL (US); Terrance J. Surma, Bloomingdale, IL (US); E. Joel Martin, Portland, OR (US); Jerry D. Biggs, Valparaiso, IN (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/298,359

(22) Filed: Nov. 18, 2002

(51) Int. Cl. B62H 5/00; E05B 71/00; E05B 65/12

(52) U.S. Cl. 70/258; 70/234

(57) ABSTRACT

The combination of a wheeled vehicle with a power source and a security system for the wheeled vehicle. The security system has an elongate bar secured to a support and a connecting assembly. The connecting assembly has a secured state wherein the connecting assembly cannot be separated from the elongate bar and is releasably attached to the wheeled vehicle.

### BACKGROUND OF THE INVENTION

1. Field of the Invention

This invention relates to wheeled apparatus, such as lawn and garden tractors, and the like, and, more particularly, to a security system for confining such wheeled apparatus to a prescribed space.

2. Background Art

It is common to display wheeled apparatus, such as lawn and garden tractors, at exterior locations. Exterior displays are desirable in that they prominently display the apparatus, make it convenient for prospective purchasers to closely inspect the apparatus, and avoid the need to use interior display space, which is generally limited in most establishments which offer this type of equipment. Lawn and garden tractors are, by their nature, large. Not only do they take up valuable floor space, but they present a problem in terms of transfer to and from internal display spaces. Some buildings do not have doors with a width sufficient to permit passage of the lawn and garden tractors. Even if adequate door width is available, it may be difficult to maneuver the apparatus to the desired display location through available passageways and around other displays.

Additionally, lawn and garden tractors are generally quite heavy. Maneuvering them without operating the power sources thereon may be difficult. If the power source is required to be operated, dangerous exhaust fumes are generated within the interior space and are both unpleasant and dangerous.

While outdoor storage eliminates the problems, and affords the advantages, described above, it introduces problems with security. To reduce the likelihood of theft, purveyors of this type of equipment must contend with the problems of either moving equipment indoors at times when the sales establishment is closed, or securing the apparatus at an outside display location. Since the former is not generally practical, a more common practice is to incorporate systems which deter theft of the exteriorally displayed equipment.

One common system is to use a chain tether which is attached serially through a number of pieces of equipment and secured as with a padlock. This system can generally be defeated by cutting the lock or chain and thereafter separating the chain from selected, or all of the, associated equipment. Once this occurs, all of the equipment becomes unprotected and can be easily removed from the premises.

Aside from the fact that the chain-type security system has limited effectiveness from a security standpoint, it also presents an inconvenience for the store operator. If a device at an intermediate location on the chain is to be separately perused or purchased by an individual, a substantial length of chain may have to be repositioned to free the desired equipment and then rethreaded through a number, or all, of the remaining pieces of equipment to re-secure the same.

The inconvenience of the chain-type system has often led businesses to avoid altogether any type of security system. Instead, the business operator may rely on the size and weight of the equipment alone as a deterrent to theft. However, lawn and garden technology has evolved to the point that some of the equipment is sufficiently expensive that a purveyor cannot take the risk of leaving it unsecured outside a sales establishment.

Designers of security systems are constantly seeking ways to permit exterior display of this type of equipment while preventing unauthorized removal, while at the same time permitting convenient release of a particular piece of equipment at the time of an authorized purchase or test operation.

### SUMMARY OF THE INVENTION

In one form, the invention is directed to the combination of a wheeled vehicle with a power source and a security system for the wheeled vehicle. The security system has an elongate bar secured to a support and a connecting assembly. The connecting assembly has a secured state wherein the connecting assembly cannot be separated from the elongate bar and is releasably attached to the wheeled vehicle.

In one form, the length of the elongate bar extends in a horizontal direction.

In one form, the connecting assembly is a U-shaped element which straddles the elongate bar.

In one form, the U-shaped element has a free end that is releasably attached to the wheeled vehicle.

In one form, the wheeled vehicle has a hitch assembly with a first opening therethrough and the free end of the U-shaped element is connected to the hitch assembly by directing the male element through the first hitch assembly opening and the free end of the U-shaped element.

The U-shaped element may have spaced, first and second legs at the free end thereof. In one form, there is a second opening in the first leg and a third opening in the second leg and a part of the hitch assembly resides between the first and second legs. The first opening is in the part of the hitch assembly. The male element extends through the first, second and third openings.

In one form, the male element has an enlarged head and a free end spaced from the enlarged head. The enlarged head cannot pass through the second opening. The securing system may further include a locking assembly operative at the free end of the male element to prevent withdrawal of the male element from the first, second and third openings.

In one form, the connecting assembly can be repositioned along the length of the elongate bar.

The combination may further include a second wheeled vehicle and a second connecting assembly, with the second connecting assembly having a secured state wherein the second connecting assembly cannot be separated from the elongate bar and is releasably attached to the second wheeled vehicle.

The elongate bar may have first and second offset ends secured to the support.

In one form, the elongate bar has a hollow tube and further includes an insert within the elongate tube to obstruct cutting through of the hollow tube.

The insert may be a hardened element, such as a cable.

In one form, the elongate bar has a rounded outer surface and the connecting assembly is a U-shaped element with a byte portion against which the rounded outer surface of the elongate bar nests.

The U-shaped element may have a surface at the byte portion that is complementary to the rounded outer surface of the elongate bar and which guides relative movement between the elongate bar and U-shaped element along the length of the elongate bar.

The invention is further directed to a method of securing a wheeled vehicle at a desired site. The method includes the steps of: fixing an elongate bar to a support at the desired site; directing a U-shaped element having spaced legs and a byte portion relative to the elongate bar so that the elongate bar moves between the spaced legs towards the byte portion; and releasably securing at least one of the legs to the wheeled vehicle so that the U-shaped element cannot be separated from the wheeled vehicle or the elongate bar.

In one form, the step of releasably securing at least one of the legs involves captively situating a portion of a hitch assembly on the wheeled vehicle between the spaced legs and directing a male element through the spaced legs and the portion of the hitch assembly.

In one form, the male element has an enlarged head and a free end spaced from the enlarged head. The step of releasably securing at least one of the legs to the wheeled vehicle further involves the step of directing the free end of the male element through the spaced legs and the portion of the hitch assembly so that the free end of the male element is exposed and operatively connecting a locking assembly to the free end of the male element to prevent withdrawal of the free end of the male element from the spaced legs and the portion of the hitch assembly.

The method may further include the step of guidingly moving the U-shaped element along the length of the elongate element to a desired location.

The method may further include the steps of directing a second U-shaped element having spaced legs and a second byte portion relative to the elongate bar so that the elongate bar moves between the spaced legs on the second U-shaped element towards the second byte portion and releasably securing at least one of the legs on the second U-shaped element to a second vehicle so that the second U-shaped element cannot be separated from the second wheeled vehicle or the elongate bar.

### BRIEF DESCRIPTION OF THE DRAWINGS

FIG. 1 is a schematic representation of a security system according to the present invention, operatively connected to a plurality of wheeled vehicles;

FIG. 2 is a perspective view of the inventive security system operatively connected to one wheeled vehicle in the form of a lawn/garden tractor;

FIG. 3 is a perspective view of a bar on the inventive security system;

FIG. 4 is an enlarged, perspective view of a U-shaped saddle element which receives the bar and releasably connects to a vehicle to be secured;

FIG. 5 is an enlarged, perspective view of a pin which passes through the U-shaped saddle element and a part of the wheeled vehicle;

FIG. 6 is an enlarged, fragmentary, side elevation view of the connection between a vehicle hitch assembly and the U-shaped saddle in FIG. 4 using the pin in FIG. 5;

FIG. 7 is an enlarged, cross-sectional view of the bar taken along line 8-8 in FIG. 3 and showing inserts which inhibit cutting of the bar and removal of the U-shaped saddle elements in the event that the bar is severed; and

FIG. 8 is an enlarged, elevation view of a pin as in FIG. 5 with a keyed locking system operatively connected thereto to prevent withdrawal of the pin from the U-shaped saddle element and hitch assembly.

### DETAILED DESCRIPTION OF THE DRAWINGS

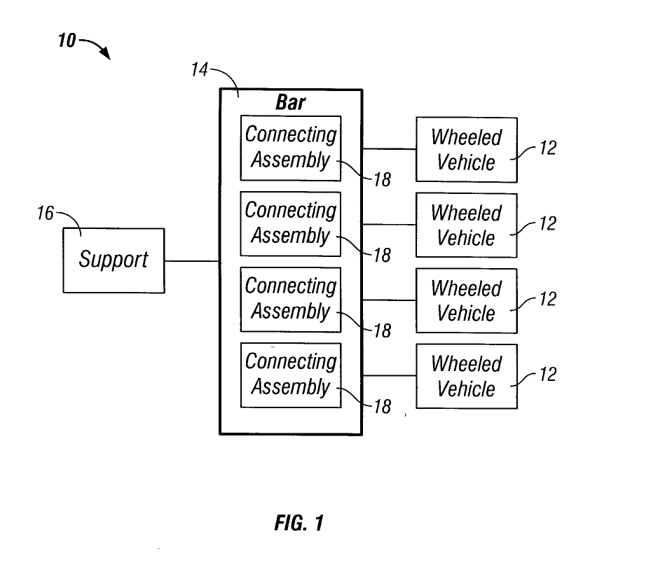

Referring initially to FIG. 1, a schematic representation of the inventive security system is shown at 10, in association with a number of wheeled vehicles 12. The number of vehicles 12 to be secured by the security system 10 may vary from a single vehicle 12 to a multitude of such vehicles 12. The nature of the vehicle 12 is not critical to the present invention. The security system 10 is particularly adaptable to larger sized vehicles 12, such as lawn and garden tractors, but is not so limited. It is adaptable to any wheeled vehicles having an accessible structural element to which the security system 10 can be releasably connected. The security system 10 could work on different vehicle designs, including even automobiles, but is particularly adapted to powered vehicles with a hitch assembly, such as the lawn and garden tractors discussed above. Accordingly, the description of the invention herein, while not so limited, will be directed to a structure and method for securing lawn and garden tractors.

The security system 10 consists of an elongate bar 14, which is maintained in an elevated position relative to a support 16 so that the length of the bar 14 extends generally horizontally. Connecting assemblies 18 are provided, one in association with each of the wheeled vehicles 12. The connecting assemblies 18 are separable, at least from the wheeled vehicles 12, and preferably are repositionable along the length of the bar 14 relative to each other. In the embodiment shown, the connecting assemblies 18 are fully separable from each other and the bar 14.

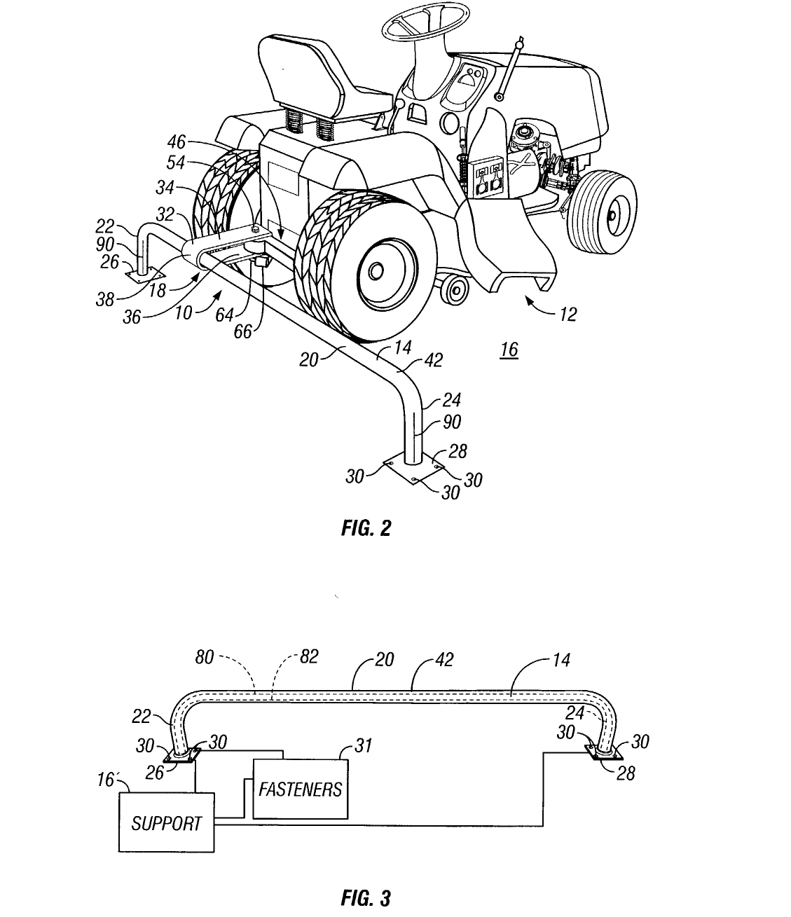

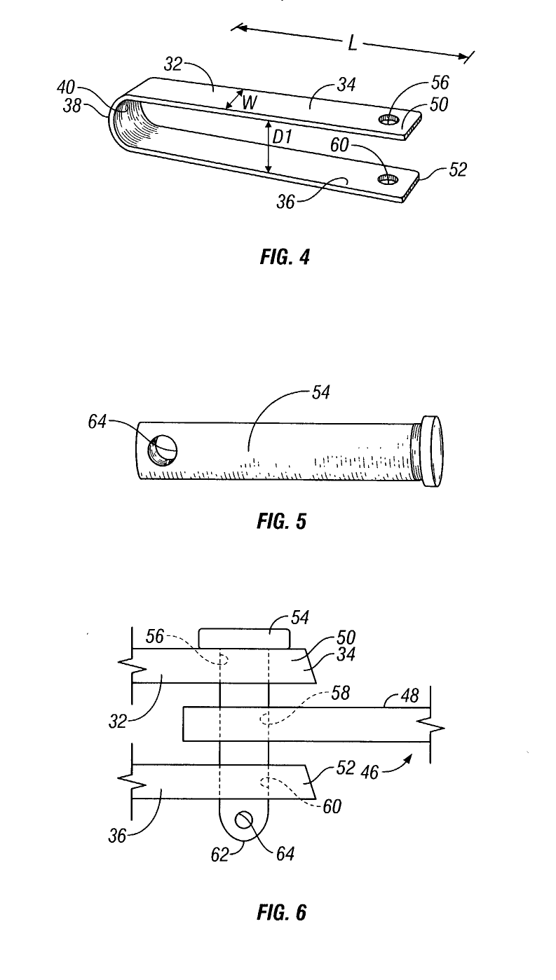

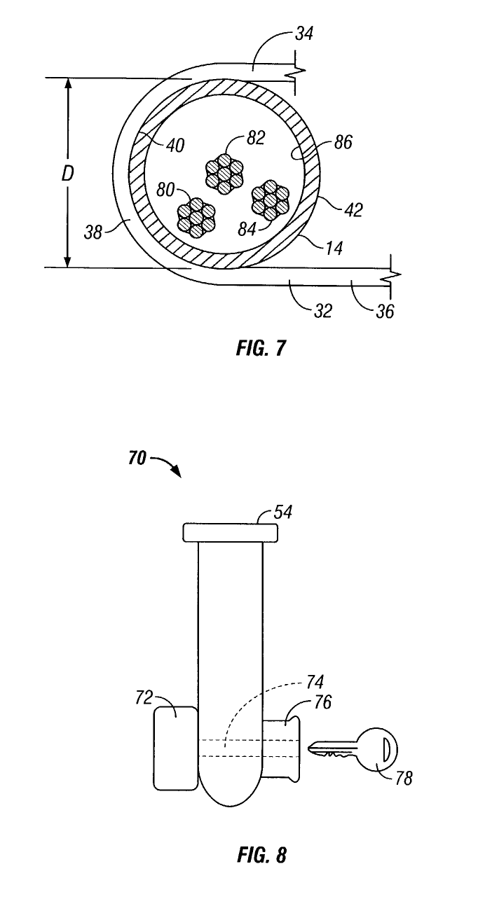

The details of the security system 10 are shown in FIGS. 2-8. The bar 14 may have either a solid or a hollow construction. In the embodiment shown, the bar 14 is a tubular, hollow bar and has a diameter D on the order of 1-3 inches. The bar 14 is formed from a single piece with an elongate base 20 and spaced, depending legs 22, 24. The base 20 and legs 22, 24 cooperatively define a “U” shape. The legs 22, 24 are each secured to a mounting base 26, 28, respectively, as by welding. The mounting bases 26, 28 are in turn secured to a support 16 (FIG. 1), which may be the surface supporting the vehicle 12, or especially designed supports 16′ (FIG. 3), such as a poured concrete base, a metal base, or the like. The mounting bases 26, 28 are preferably flat plates with a series of bores 30 to accept suitable fasteners 31 which penetrate or are otherwise secured to the supports 16, 16′. The mounting bases 26, 28 can be secured using fasteners 31 with special security features, known to those skilled in the art, to obstruct unauthorized removal thereof.

Alternatively, the bar 14 may be permanently anchored at a desired location, as by embedding the legs 22, 24 in concrete. Further, the U-shaped configuration of the bar 14 is not required. What is important is to have a horizontally extending, securely anchored length of an elongate element which cooperates with the connecting assemblies 18, as hereinafter described.

Each connecting assembly 18 consists of a U-shaped element/saddle 32 with spaced, elongate legs 34, 36 connected by a curved byte portion 38. The legs 34, 36 are spaced from each other a distance D1 that is slightly greater than the diameter D of the bar 14. The byte portion 38 has a curved surface 40 which conforms substantially to the curved outer surface 42 of the bar 14. The legs 34, 36 have a length L that may vary anywhere from several inches to several feet, depending upon the particular application.

Preferably, the saddle 32 is fully separable from the bar 14 and operatively assembled thereto by directing the saddle 32 over the bar 14 so that the bar moves between the legs 34, 36 to against the byte portion 38. The legs 34, 36 project in cantilever fashion to a point at which they can be releasably connected to, in this case, a vehicle 12 in the form of a garden tractor. The garden tractor 12, like most garden tractors, has a hitch assembly at 46 with a rearwardly projecting portion in the form of a tongue 48, which accommodates accessories commonly drawn thereby in the agricultural environment, i.e. trailers, etc.

With the saddle 32 operatively connected to the bar 14, the leg free ends 50, 52 can be directed respectively to above and below the hitch tongue 48 in straddling relationship, as shown in FIGS. 2 and 6. A male element, in the form of a headed pin 54, can then be directed through aligned openings 56, 58, 60 in the leg 34, tongue 48, and leg 36, consecutively. The free end 62 of the pin 54 projects to below the saddle leg 36, once fully inserted, so that an opening 64 therethrough, orthogonal to the length of the pin 54, is exposed to receive the shackle 64 of a conventional padlock 66 (FIG. 1). The padlock 66 prevents withdrawal of the pin 54 from the openings 56, 58, 60.

Other locking systems are available for preventing withdrawal of a like pin 54. For example, as shown in FIG. 8, a locking system is shown at 70 consisting of a headed male element 72 with a shaft 74 which can be selectively engaged with, and released from, an adaptor 76 which is operated through a key 78.

The saddles 32 and bar 14 are relatively dimensioned so that the saddles 32 can be slid guidingly along the length of the bar 14. This permits a desired anchoring location for one vehicle 12, or a plurality of vehicles 12 to be conveniently selected. This feature is desirable in that it facilitates the connection of the vehicle 12 and an aesthetically desirable alignment of the vehicles 12 on the security system 10.

In the event that the bar 14 is hollow, i.e, tubular, in the absence of being hardened, it may be prone to being severed. To avoid defeat of the security system 10 by cutting of the bar 14, one or more elongate inserts 80, 82,84 can be directed through the hollow 86 over the entire length thereof. The inserts 80, 82, 84 may be made from a hardened material, such as aircraft cable, which is not susceptible to being cut by a hack saw. Thus, even if a would-be thief was successful in severing the bar 14, the saddles 32 would still be inseparable from the inserts 80, 82, 84, spanning along the length thereof.

To defeat the connection of the saddle 32, the saddle legs 34, 36 would both have to be cut by the would-be thief. The saddle 32 can be made from a hardened material. Even with a non-hardened material, cutting of both legs with a hack saw would be very time consuming. For this reason, the saddles 32 are made with a leg width W in the range of 1-6 inches, but could be more or less. The pin 54 and padlock 66 can be made in a conventional manner so as to be highly resistant to tampering.

As a further safeguard against tampering, the legs 22, 24 can be modified, as shown in FIG. 1. A hardened strip of material, or a heavy weld line 90 can be provided at one or more locations on each of the legs 22, 24. The hardened strip/weld line 90 prevents the use of a conventional pipe cutter to sever the legs 22, 24.

With the inventive structure, a display can be customized by choosing a desired bar length and utilizing the desired number of saddle and pin combinations necessary to secure the vehicles 12.

The foregoing disclosure of specific embodiments is intended to be illustrative of the broad concepts comprehended by the invention.

1. In combination:
a) a wheeled vehicle with a power source; and
b) a security system for the wheeled vehicle, the security system comprising:
an elongate bar secured to a support,
the elongate bar having a length; and
a connecting assembly,
the connecting assembly having a secured state wherein the connecting assembly cannot be separated from the elongate bar and is releasably attached to the wheeled vehicle.

2. The combination according to claim 1 wherein the length of the elongate bar extends in a horizontal direction.

3. The combination according to claim 1 wherein the connecting assembly comprises a U-shaped element which straddles the elongate bar.

4. The combination according to claim 3 wherein the U-shaped element has a free end that is releasably attached to the wheeled vehicle.

5. The combination according to claim 4 wherein the wheeled vehicle has a hitch assembly with a first opening therethrough and the free end of the U-shaped element is connected to the hitch assembly by directing a male element through the first hitch assembly opening and the free end of the U-shaped element.

6. The combination according to claim 5 wherein the U-shaped element has spaced first and second legs at the free end of the U-shaped element, there is a second opening in the first leg and a third opening in the second leg, a part of the hitch assembly resides between the first and second legs, the first opening being in the part of the hitch assembly, and the male element extends through the first, second and third openings.

7. The combination according to claim 6 wherein the male element has an enlarged head and a free end spaced from the enlarged head, the enlarged head cannot pass through the second opening, and the security system further comprises a locking assembly operative at the free end of the male element to prevent withdrawal of the male element from the first, second, and third openings.

8. The combination according to claim 1 wherein the connecting assembly can be selectively repositioned along the length of the elongate bar.

9. The combination according to claim 8 further comprising a second wheeled vehicle and a second connecting assembly, the second connecting assembly having a secured state wherein the second connecting assembly cannot be separated from the elongate bar and is releasably attached to the second wheeled vehicle.

10. The combination according to claim 1 wherein the elongate bar has first and second offset ends secured to the support.

11. The combination according to claim 1 wherein the elongate bar comprises a hollow tube and further comprising an insert within the elongate tube to obstruct cutting through of the hollow tube.

12. The combination according to claim 11 wherein the insert comprises a hardened element.

13. The combination according to claim 12 wherein the hardened element comprises a cable.

14. The combination according to claim 1 wherein the elongate bar has a rounded outer surface and the connecting assembly comprises a U-shaped element with a byte portion against which the rounded outer surface of the elongate bar nests.

15. The combination according to claim 14 wherein the U-shaped element has a surface at the byte portion that is complementary to the rounded outer surface of the elongate bar and which guides relative movement between the elongate bar and U-shaped element along the length of the elongate bar.

16. A method of securing a wheeled vehicle at a desired site, the method comprising the steps of:
fixing an elongate bar to a support at the desired site;
directing a U-shaped element having spaced legs and a byte portion relative to the elongate bar so that the elongate bar moves between the spaced legs toward the byte portions; and
releasably securing at least one of the legs to the wheeled vehicle so that the U-shaped element cannot be separated from the wheeled vehicle or the elongate bar.

17. The method of securing a wheeled vehicle at a desired site according to claim 16 wherein the step of releasably securing at least one of the legs comprises captively situating a portion of a hitch assembly on the wheeled vehicle between the spaced legs and directing a male element through the spaced legs and the portion of the hitch assembly.

18. The method of securing a wheeled vehicle at a desired site according to claim 17 wherein the male element has an enlarged head and a free end spaced from the enlarged head and the step of releasably securing at least one of the legs to the wheeled vehicle further comprises the step of directing the free end of the male element through the spaced legs and the portion of the hitch assembly so that the free end of the male element is exposed and operatively connecting a locking assembly to the free end of the of the male element to prevent withdrawal of the free end of the male element from the spaced legs and the portion of the hitch assembly.

19. The method of securing a wheeled vehicle at a desired site according to claim 18 further comprising the step of guidingly moving the U-shaped element along the length of the elongate element to a desired location.

20. The method of securing a wheeled vehicle at a desired site according to claim 16 further comprising the steps of directing a second U-shaped element having spaced legs and a second byte portion relative to the elongate bar so that the elongate bar moves between the spaced legs on the second U-shaped element towards the second byte portion, and releasably securing at least one of the legs on the second U-shaped element to a second wheeled vehicle so that the second U-shaped element cannot be separated from the second wheeled vehicle or the elongate bar.
